(19) United States
(12) Patent Application Publication
(10) Pub. No.: US 2008/0177773 A1
(43) Pub. Date: Jul. 24, 2008

(54) CUSTOMIZED MEDIA SELECTION USING DEGREES OF SEPARATION TECHNIQUES

(75) Inventors: Gregory J. Boss, American Fork, UT (US); Fonda J. Daniels, Cary, NC (US); Vincenzo V. Diluoffo, Sandy Hook, CT (US); Rick A. Hamilton, Charlottesville, VA (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/625,524

(22) Filed: Jan. 22, 2007

(51) Int. Cl. G06F 7/00; G06F 3/00

(52) U.S. Cl. 707/102; 715/745; 725/46

(57) ABSTRACT

A method and interface for providing media content to users across a network. The method includes the steps of presenting a media interface to the user that indicates the content provider for the media receiver and buffering adjacent content providers to allow the user to change providers without any delays. The selection of the content providers can be done in an initial set up step with user inputs, or automatically from the last settings on the interface of from defaults. The content provider information and locations are maintained in a registry with which the interface interacts if necessary. The interface includes a prompt for user inputs, the interface with the registry, a display for the user and a control that allows the user to select content providers. The present invention discusses a mechanism for changing digital content providers, which isn't what this invention is based upon.

### BACKGROUND OF THE INVENTION

1. Field of the Invention

This invention generally relates to mobile media playback devices, and more specifically, the invention relates to customized media selection for such playback devices.

2. Background Art

Today, many mobile media playback devices allow users to receive and playback media, such as music, videos, pictures, games and images, in the form of digital content. Exemplary mobile media playback devices include cell phones, personal digital assistants, satellite radios, digital cameras, digital video recorders and combination devices. Typically, these devices have a relatively small memory capacity that allows for the storage and playback of a limited amount of content. As a result, the user does not have significant control to hear or see what he or she wants.

The manual selection of songs to add to a playlist can be time consuming and tedious. Attempts have been made to automate the playlist selection process. One method includes selecting a random group of songs from the music library. This method can result in the playlist including a large number of songs that are not liked by the user.

Another prior art method includes generating a playlist that includes songs most liked by the user. This approach can lead to degenerative playlists. The same songs played over and over again can dominate the playlists. Some systems rely on the use of metadata to compare attributes of new songs to the attributes of songs that a user has indicated as enjoying. Without the required metadata, such systems do not work.

These drawbacks are not unique to mobile audio players and also apply to other mobile media playback devices.

Therefore, there is a need in the art to enable users of mobile media playback devices to enjoy their preferred content without having to constantly select the content by, for example, scanning or changing channels on radios.

### SUMMARY OF THE INVENTION

An object of this invention is to provide customized media selection for mobile media playback devices

Another object of the invention is to present a user of a mobile media playback device with a more accurate and dynamic content selection by matching sets of collections based on degrees of separation.

These and other objectives are attained with a method and system for customized media selection using degrees of separation techniques. A user profile establishes the initial collection of content and guides a subsequent pool matching techniques. Musical content is represented in a taxonomy, hence comparing the user profile to the taxonomy will easily yield inference relationships between the data sources and will consequently deliver personalized musical content to the user.

The preferred embodiment of the invention includes three main aspects: 1) A taxonomy for music content; 2) The creation of a listener's music profile; 3) An algorithm or agent to support the search and data relationship clustering.

The first part of this invention is the taxonomy concept of how data is stored. The current music industry data is stored as simple classification like name of song, title of album, artist name and maybe year. This invention increases the classification type by allowing more categories to be defined. This complex data classification allows the digital content to be structured in tree like relationships, rather than tuples. This tree like structure allows relationships to be associated in different forms. An example of this is that a type of beat or lyric from an artist can be matched with another artist or song. This type of taxonomy allows for complex data search and match techniques.

The second part of this invention is the user profile. A music profile is a mechanism that allows the listener to identify the types of music and/or lyrics, if any. The profile is also used as input data for the agent, so that data relationship can be formed. These data relationship are not the same as same artist or category, but rather a degree of separation. An example of this separation is that if a listener is in the mood to hear a certain melody, that user profile piece of data is used by the agent to match and retrieve the exact or closest result. The result set is then fed to the subscriber's device.

The final part of this invention is the agent for relationship creation. Creating a taxonomy data structure and allowing the user to provide his/her preferences in the form of a profile can invoke an agent to analyze both the user profile and data structure to create inference logic between both data sources. The result set can be offered to the listener as choices or simply provided to the device. The agent provides a more targeted result selection using both user input and back-end data.

The combination of these three modules provides a unique service for music listeners using pervasive devices. The listener is not purchasing songs like MP3, but rather using the pervasive device as a temporary storage device to hold and stream the digital content. The listener still has the control to change the music content being delivered by altering the profile or using normal functions by switching channels for regular radio service.

This invention provides a solution to closely match a listener's preference by song, artist, music category (pop, country, classical), album, beat or instrument type. This solution could be offered as a service, i.e., adding value to satellite subscribers where a listener is able to select music using the techniques described above. This automated technique allows the user to enjoy their preferred music ensemble without having to constantly select choice music by scanning or changing channels on radios.

The discussion herein refers principally to the multimedia type of audio. It should be noted, however, that the present invention applies to all media types such as video, music, books-on-tape, and others.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a user/system flow for implementing the present invention.

FIG. 2 shows an example of a user profile that may be used in the present invention.

FIG. 3 is a diagram that describes the degrees of separation technique that may be employed in the present invention.

### DETAILED DESCRIPTION OF THE PREFERRED EMBODIMENTS

The present invention, generally, provides customized media selection for mobile media playback devices, and the preferred embodiment of the invention has three main aspects: 1) A taxonomy for music content; 2) The creation of a listener's music profile; 3) An algorithm or agent to support the search and data relationship clustering.

The first part of this invention is the taxonomy concept of how data is stored. The current music industry data is stored as simple classification like name of song, title of album, artist name and maybe year. This invention increases the classification type by allowing more categories to be defined. This complex data classification allows the digital content to be structured in tree like relationships, rather than tuples. This tree like structure allows relationships to be associated in different forms. An example of this is that a type of beat or lyric from an artist can be matched with another artist or song. This type of taxonomy allows for complex data search and match techniques.

The second part of this invention is the user profile. A music profile is a mechanism that allows the listener to identify the types of music and/or lyrics, if any. The profile is also used as input data for the agent, so that data relationship can be formed. These data relationship aren't the same as same artist or category, but rather a degree of separation. An example of this separation is that if a listener is in the mood to hear a certain melody, that user profile piece of data is used by the agent to match and retrieve the exact or closest result. The result set is then fed to the subscriber's device.

The final part of this invention is the agent for relationship creation. Creating a taxonomy data structure and allowing the user to provide his/her preferences in the form of a profile can invoke an agent to analyze both the user profile and data structure to create inference logic between both data sources. The result set can be offered to the listener as choices or simply provided to the device. The agent would provide a more targeted result selection using both user input and back-end data.

The combination of these three modules provides a unique service for music listeners using pervasive devices. The listener is not purchasing songs like MP3, but rather using the pervasive device as a temporary storage device to hold and stream the digital content. The listener still has the control to change the music content being delivered by altering the profile or using normal functions by switching channels for regular radio service.

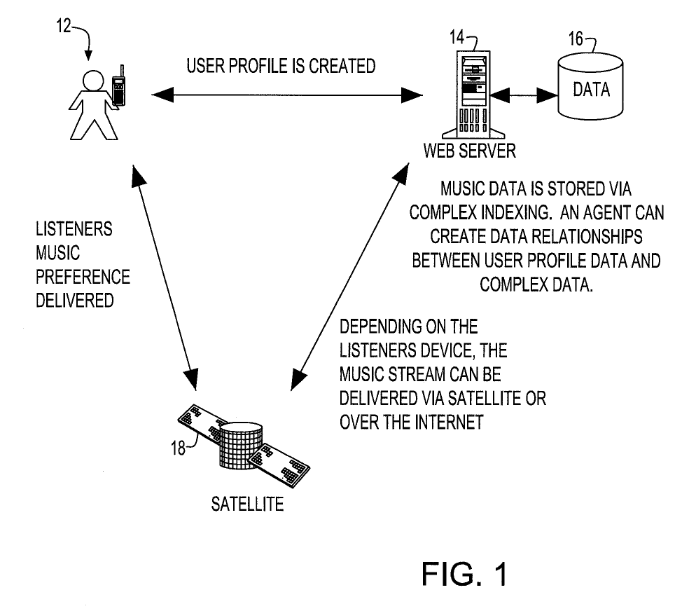

FIG. 1 is a diagram showing a user/system flow for how one creates a profile, complex data storage, agent and output to the user's device. A user 12 creates a profile that is stored on Web server 14. Music data are stored on storage device 16 via complex indexing. An agent can create data relationships between the user profile data and complex data. Depending on the listener's device, the music stream can be delivered via satellite 18 or over the Internet.

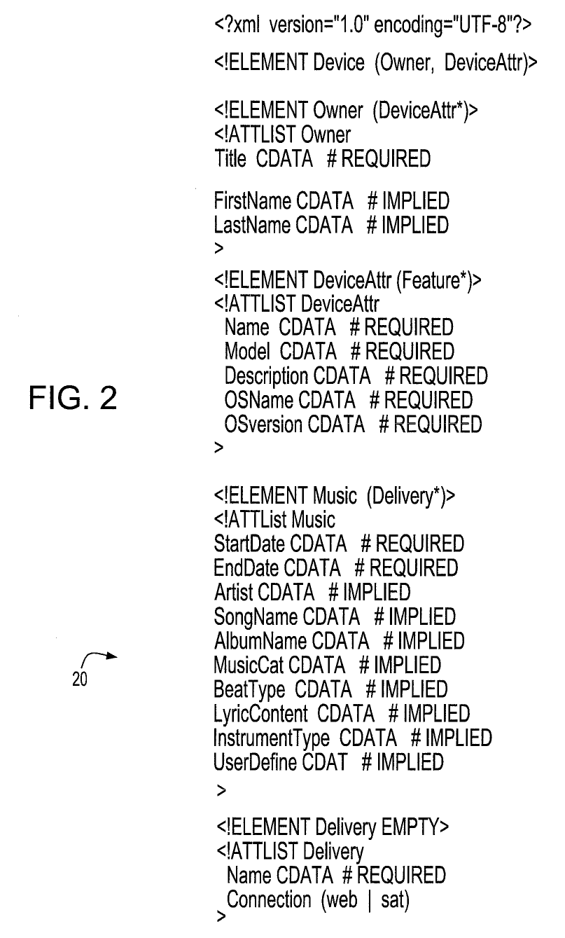

FIG. 2 shows an example of a DTD of a user profile 20. The user profile elements are expressed in XML and describe the configurable features.

A user profile can have many devices and within each device a music preference list can be created or used for each device. A user can have a number of profiles, so that he/she can choose an already created pool of songs.

The overall service can be an added value for a provider of digital content, (e.g. satellite radio). The following steps will allow a listener to obtain his/her preferred music.

1) A user will first logon to a web site using his/her userid and password provided under a subscription offering.

2) A user profile will be created and populated.

3) The server will store the profile in an XML format on the server.

4) Since the digital content has already been stored and tagged for complex data structures, this will allow the agent to maneuver within the bounds of the correct data.

5) The user will initiate an agent to be invoked to perform the relationship creation logic and return a result set.

6) The agent would analyze the user profile and begin to create the relationship structure.

7) The agent would complete the structure and return a corresponding result to the user.

8) The user at this point can change to search information in the profile or accept the result set.

9) The user would then establish a start and end date for the music pool.

10) The start and end dates can be extended at anytime.

11) The service would then begin to stream the digital content to the device.

12) The website will be the only mechanism to change the profile content. In today's pervasive world the device already supports a browser, so this should not be an inconvenient task.

One significant advantage of this invention is contained in the ability of users to sway others' listening habits. In one embodiment (a), if “Person A” musical pool and “Person B” musical pool (those tracks which they each have respectively selected) have a common song, then their mix will periodically include songs from each others' pools, up to the “new music” percentage they each indicated. In other words, if “Person A” chooses that they want to hear 20% new music, then 20% of their songs are chosen from other pools from which that person shares a common track. Those songs may be chosen randomly from overlapping pools.

In a more nuanced embodiment (b), the tracks chosen will come most heavily from those whose pools share more tracks in common with a person, up to the percentage chosen. For example, if “Person A” and “Person B” share 10% of tracks, and “Person C” and “Person A” only share 1% of tracks, the likelihood that a new song will be chosen from Person B's pool is greater than that of coming from “Person C”. If “Person A” specifies some percentage, e.g., 30% or 5% or 50%, of new tracks, “Person A” is ten times more likely to hear music from “Person B” pool than from “Person C”.

In a more adaptive embodiment (c), the percentage of new tracks, which a person is presented with, will be variable, according to the degree of commonality. In other words, if “Person A” has heavy overlap, as measured by percentage of common tracks, with “Person B”, then it follows to reason that those songs in “Person A” pool but not in “Person B” are relatively likely to be ones that “Person A” likes. In other words, if they have great commonality in selected tracks, then those remaining in “Person A” pool have a higher probability of appealing to “Person B”. Thus, “Person A” percentage of new tracks, rather than being preselected by “Person B”, may vary depending on the degree of shared commonality “Person A” has with others.

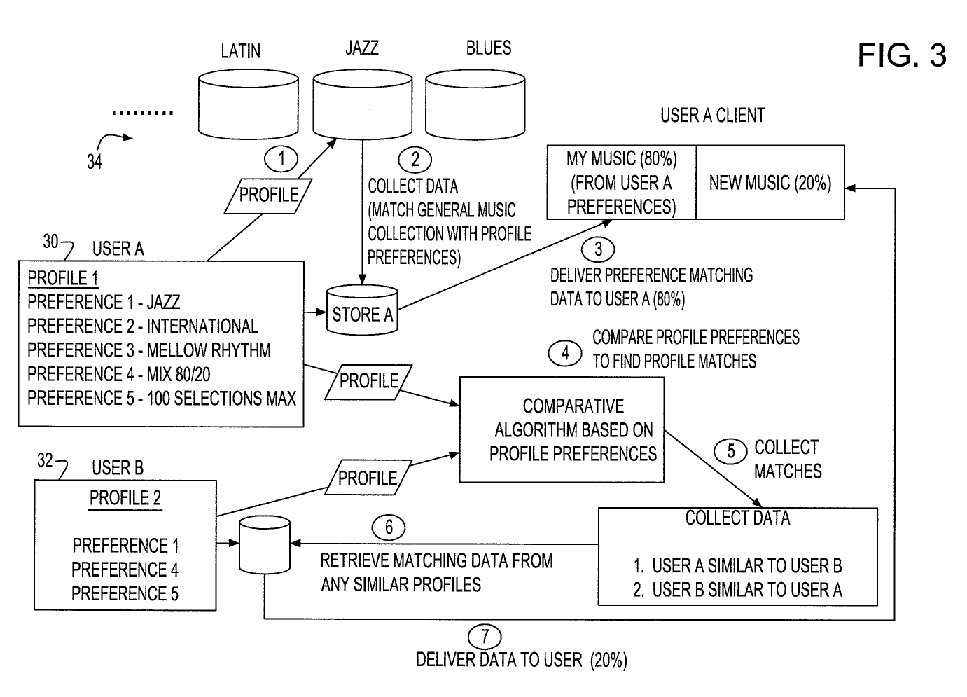

FIG. 3 is a diagram that describes the degrees of separation technique that may be employed in the present invention. User A has a profile 30 that lists five preferences, one through five; and user B has a profile 32 that lists preferences one, four and five. FIG. 3 also shows data storage devices 34 that store three types of music, Latin, jazz and blues.

In this technique, at step 1, User A creates a profile 30 with various musical preferences. Once the profile is created, the profile, at step 2, is activated and data are gathered from various music sources 34. At step 3, depending on the amount of data that is to be returned to the User, the data from the music sources is returned to the User. The User could elect to have, for example, 100 items returned and of those 100 items, 80% could come from User A's personal preferences. Therefore 20% of the 100 items could be allocated to come from other sources.

At step 4, if User A has elected to have additional music delivered to him or her, User A's profile is compared to other user profiles to determine similarities. At step 5, the list of the profiles that User A has some similarity with are collected; and at step 6, data from similar profiles that correspond to User A's profile is retrieved. At step 7, resulting content (20%) is then sent to User A for preview.

The preferred embodiment of the invention provides a number of important advantages. This invention provides a solution for presenting a user more accurate and dynamic music selections by matching sets of collections based on degrees of separation. Also, this invention provides a solution to closely match a listeners' preference by song, artist, music category (pop, country, classical), album, beat or instrument type. This solution could be offered as a service, i.e., adding value to satellite subscribers where a listener is able to select music using the techniques described above. This automated technique allows the user to enjoy their preferred music ensemble without having to constantly select choice music by scanning or changing channels on radios.

As will be readily apparent to those skilled in the art, aspects of the present invention may be realized in hardware, software, or a combination of hardware and software. Any kind of computer/server system(s)—or other apparatus adapted for carrying out various methods or features described herein—is suited. A typical combination of hardware and software could be a general-purpose computer system with a computer program that, when loaded and executed, carries out features described herein. Alternatively, a specific use computer, containing specialized hardware for carrying out one or more of the functional tasks, could be utilized.

In addition, features disclosed herein may also be embodied in a computer program product, which when loaded in a computer system is able to carry out these features. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

Also, it should be noted that, although the discussion herein refers principally to the multimedia type of audio, the present invention applies to all media types such as video, music, games, books-on-tape, and others.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of customized media selection using degrees of separation techniques, comprising the steps of:
categorizing media by using a taxonomy structure based upon media content;
defining a user profile for specifying media preferences of a user, including the steps of:
the user logging on to a web site using a userid and a password provided to the user under a subscription offering;
creating and populating the user profile; and
storing the profile in an XML format on a server; and
using an inference engine to select media based upon the user profile and the taxonomy structure, including the steps of:
the user initiating an agent to be invoked to perform relationship creation logic and to return a corresponding result set;
the agent analyzing the user profile and beginning to create the relationship structure; and
the agent completing the relationship structure and returning the corresponding result set to the user.

2. A method according to claim 1, wherein the step of using an inference engine includes the further steps of:
activating the profile and gathering data from several media sources;
returning to the user the data gathered from the media sources;
the user electing to receive a first given percentage of media items from the user's personal preferences and a second given percentage of media items from other sources;
comparing the user's profile to other user profiles to determine similarities;
collecting a list of the other user profiles that have some preferences in common with the preferences in the user's profile;
retrieving data from said other user profiles that have preferences in common with the user profile; and
sending resultant content to the user for preview.

3. A method according to claim 2, wherein the user has a mobile playback device, and the method comprises the further step of:
after returning the corresponding result set to the user, the user then establishing start and end dates for the media, and a service then streaming digital content to the mobile playback device of the user.

4. A method according to claim 3, wherein the step of establishing start and end dates includes the step of the user extending said start and end dates at any time.
